(19) United States
(12) Patent Application Publication
(10) Pub. No.: US 2022/0055080 A1
(43) Pub. Date: Feb. 24, 2022

(54) RECHARGEABLE HIGH POWER WASHER AND JETTER

(71) Applicants: Yevgeniy Galyuk, Sherman Oaks, CA (US); Aleksandr Marchuk, North Hollywood, CA (US)

(72) Inventors: Yevgeniy Galyuk, Sherman Oaks, CA (US); Aleksandr Marchuk, North Hollywood, CA (US); Shawn Bennett, Los Angeles, CA (US)

(73) Assignee: Shawn Bennett, Los Angeles, CA (US)

(21) Appl. No.: 17/405,340

(22) Filed: Aug. 18, 2021

Related U.S. Application Data
(60) Provisional application No. 63/067,214, filed on Aug. 18, 2020.

(51) Int. Cl. B08B 9/043; B08B 13/00; B08B 9/049; C02F 1/00; H01M 10/46; H01M 10/0525

(52) U.S. Cl. CPC B08B 9/0433; E03B 7/006; B08B 9/0495; C02F 1/001; C02F 1/008; H01M 10/46; H01M 10/0525; B08B 2209/04; C02F 2201/005; C02F 2201/008; C02F 2209/03; C02F 2209/005; C02F 2301/066; H01M 2220/10; B08B 13/00

(57) ABSTRACT

A jetter system for removing debris such as leaves, branches, mud, and trash from sewer pipes and from other types of pipes is disclosed. The jetter includes a rechargeable battery that provides direct current (DC), a DC/AC converter, and an AC motor that drives a water pump, or the like means for improved powering and debris removal.

### PRIORITY BENEFIT

This patent application claims priority benefit from Provisional patent application Ser. No. 63/067,214, filed Aug. 18, 2020, which is incorporated herein in its entirety.

### FIELD OF THE DISCLOSURE

The present disclosure relates to methods and devices for removing debris from pipes and conduits, such as sewer lines. The disclosure relates to water pumps, hoses, and sources of electric power for driving the water pumps.

### BACKGROUND OF THE DISCLOSURE

Pressure washers and sewer line j etters are devices that utilize a source of power such as an electric motor, hydraulic motor, or diesel engine to engage a high pressure water pump to accelerate input water to extremely high pressures for the purpose of unblocking built up restrictions in plumbing or efficiently cleaning surfaces by high pressure output water. These devices exist in many embodiments and encompass a variety of different water pressure outputs as well as applications.

Most HIGH pressure, commercial sewer jetting assemblies rely on diesel engines to turn the high pressure water pump. Existing diesel powered systems are prone to maintenance issues which translate to a higher cost of ownership, downtime and lost revenues for companies specializing in this industry. One of the downsides of diesel powered high pressure water jetting systems is the idling of the diesel engine during non-operation. Since the diesel engine is the source of power for certain hydraulic components on hydro jetting systems, the engine must be on even during procedures which do NOT require a high pressure stream of water being pushed to the jetting hose or pressure washer gun. While the engine is idling, the water pump is constantly engaged and water is flowing through a network of plumbing which returns the output water to the holding tank. Several problems can occur, one being that the water pump is in use whether or not it is actually performing its primary objective of moving water to a hose in a sewer line to unblock a restriction. This ultimately lowers the life expectancy of the seals and mechanical components of the water pump. Likewise, a series of additional plumbing and manifolds need to exist on the system to divert the idle flow of water back to the holding tank until that water needs to be pushed to the hose for the purpose of unblocking a restriction or blockage in a drain or sewer line.

Smaller, lower pressure systems are typically powered by an electric motor and are generally used as pressure washers or can be utilized to unblock small blockages in residential plumbing. The low pressure systems require a AC power source which is usually provided by a smaller diesel or gas generator, into which, the pressure washer/jetter system plugs into. Likewise any 120 volt wall receptacle can provide the necessary power but limits the operator to having a source of city power at the jobsite.

The present disclosure sets forth a novel, improved system which incorporates a set of rechargeable DC batteries, DC to AC converter, DC to DC converter, PLC logic, AC motor, high pressure water pump, high pressure hose, high pressure plumbing, valves, manifolds, sensors and gauges, which simplify and improve upon existing systems and methods. The systems of the present disclosure allow for consistent commercial application of a mobile sewer jetting or pressure washing system capable of pressures between 500 psi all the way up to 6000 psi at the hose, without the need for fossil fuel engines, generators or hardline AC power supply to deliver power to the power station of the high pressure pump mechanism. The improved systems herein, provide a level of power and reliability expected in traditional diesel powered pressure washer systems and sewer jetter systems while eliminating unnecessary componentry, the need for fossil fuels, exhaust, hydraulic pumps, hydraulic components, as well as maintenance. PSI means, pounds per square inch.

### SUMMARY OF THE DISCLOSURE

Briefly stated, a jetter system for removing debris such as leaves, branches, mud, and trash from sewer pipes and from other types of pipes is disclosed. The jetter includes a rechargeable battery that provides direct current (DC), a DC/AC converter, and an AC motor that drives a water pump, or the like means for improved powering and debris removal.

What is provided is a system for cleaning debris from pipes and sewers, wherein the system is capable of removing debris from one or more of indoor plumbing, underground plumbing, out-of-doors plumbing, irrigation conduits, sewage systems that carry industrial wastewater, sewage systems that carry sanitary waste, and sewage systems that carry rainwater, wherein the system comprises:

(A) A series of electrical devices that can be represented on a flow chart as being closely related, wherein these electrical devices comprise: (a) An alternating current (AC) battery charger that can accept either 120 volt or 240 volt AC power from any commercial or residential powergrid, wherein the battery charger converts incoming AC to the necessary DC output in order to recharge a battery pack, (b) A rechargeable battery pack that supplies direct current (DC), (c) A DC to AC converter that converts direct current from said battery pack to alternating current, and wherein the alternating current is used to drive an electric motor, (d) An electric motor that is driven by the alternating current (AC) produced by the DC to AC converter, (e) A water pump for pumping water from a water tank to a manifold, wherein the electric motor is coupled to the high pressure water pump via jaw couplings, gear drive, or belt drive in a manner to directly or indirectly drive the water pump shaft,

A series of fluid flow devices that can be represented on a flow chart as being operably linked, wherein these fluid flow devices comprise: (a) A water tank for storing water, wherein the stored water is used for said cleaning debris; (b) A manifold and a hose reel, wherein said water pump for pumps water from the water tank to a manifold and then to a hose reel; (c) Said manifold that is capable of receiving water from said pump, wherein the manifold is also capable of directing water to said hose reel, and wherein the manifold is also capable of directing water back to said water tank, wherein the percentage of water directed to hose reel and percentage of water directed back to water tank is controllable by the combination of a pressure sensor and a Programmable Logic Controller (PLC) assembly that comprises a PLC logic,

(C) A plurality of regulatory devices that regulate water flow, the regulatory devices comprising: (a) A pressure sensor operably linked to the manifold, wherein the digital pressure sensor is operably linked to a PLC assembly, (b) Wherein the PLC assembly comprises an HMI screen, wherein the pressure sensor functions to measuring output water line pressure and displaying said pressure reading onto the HMI screen, and wherein the pressure sensor also functions to act as an over pressure safety switch which is triggered by the PLC logic when a pressure above the set safety limit is experienced in the water output line, and wherein the set safety limit pressure can be adjusted within the PLC logic to accommodate different water pumps as well as different hoses, and wherein the pressure safety limit can be adjusted from 1 pounds per square inch (psi) to 10000 psi, (c) An auxiliary water line (“jump jet” line or “pulse jet” line) and a jump jet valve, wherein the flow of water from the water pump to the jump jet line is controllable by the jump jet valve, wherein when the jump jet valve is in the OPEN position, water from a single piston in the pump is diverted back to the water tank, and wherein water from the single piston in the pump is diverted back to the water tank what is created is a pulse in the main water (the output hose).

What is also embraced is the above system, wherein the pulse in the jump jet line is capable of enhancing the ability of the hose to enter a heavily blocked pipe, and enhances the ability of the hose to clear blockage that is past about 100 feet of pipe, and wherein the pulsation in the hose to allow the hose to move more freely through debris in water pipes, and to more easily to navigate bends in water pipes.

Further contemplated is the above system, wherein the hose reel supplies output water to a high pressure hose that is comprised by the hose reel, wherein the hose reel is equipped with a reel motor for retracting the hose, wherein the reel motor is a 12 volt motor that is powered by said battery pack via the step down converter that receives 50V from the batteries and outputs 12V to the electric motor, wherein the motor can be varied in line voltage, such as a line voltage that is 12V, 24V, or 120V.

Also provided is the above system, further comprising regulatory devices that comprise an analog needle valve that resides in-line between the manifold and the water tank, and wherein the analog needle valve is connected to the manifold, and wherein the analog needle valve is capable of lowering the pressure in the main water output line by redirecting water flow back to the water tank, and wherein this pressure reducing valve allows operators to meter the pressure in the output line when less pressure is needed, and wherein less pressure is typically needed for smaller line jobs where a smaller internal diameter hose is required to fit small kitchen pipes, an analog spring action pressure gauge that is not in line with any device that is operably linked with the water pump and with the water tank, but instead is linked directly to only to the manifold, and wherein the spring action pressure gauge is capable of reading up to the maximum output pressure of the water pump.

Moreover, what is also provided is the above system, further comprising a charger and a charger inlet, wherein the charger is operably linked to said one or more batteries and is capable of recharging said one or more batteries, and wherein the charger inlet can receive alternating current (AC) from a 120/240 volt AC utility line,

Provided is the above system, further comprising a filter and a filter housing that resides inside the fluid line between the water tank and the water pump, wherein the filter is capable of removing sediment, sand, and plant matter, that originated from the water tank.

Additionally, what is contemplated is the above is portable and that is optionally mounted on a truck, mounted on a trailer, or mounted on a frame that includes wheels that support the frame on a road or on the ground.

In a non-portable embodiment, what is provided is the above system that is not portable and that is optionally mounted on a ground-based platform.

What is provided is the above system, that further includes a 12Volt DC pump that is controlled via the PLC assembly, wherein the small 12Volt DC pumps provides cooling for the battery pack, and wherein the cooling is provided by liquid is drawn from the water tank.

In a J Box embodiment, what is provided is the above system, further comprises a J Box, wherein the J Box comprises: (i) One electrical relay to isolate battery pack from the system when the disconnect switch is turned OFF (PLC function), (ii) One electrical relay to isolate battery pack from the control system when the key switch is turned off (part of PLC function), (iii) Two fuses for circuit protection, and (iv) One shunt resistor for determining a battery's charge status. Also provided is the above system, wherein said J Box is operably linked with said DC to AC converter.

In methods for manufacturing embodiments, what is provided is a method for manufacturing the above system, the method comprising assembling a plurality of devices for transmitting fluids, and comprising assembling a plurality of electrical components, wherein the method for assembling devices for transmitting fluids comprises the steps of connecting: (i) Water tank, wherein the water tank is immediately downstream of jump jet valve and pressure relief valve, and is immediately upstream of filter housing and coolant pump, (ii) Filter housing that comprises a filter, (iii) Water pump for driving the circulation of water from water tank through filter through jump jet line to jump jet valve, and then back to the water tank, wherein the pump is also used for driving water from water tank through filter to manifold through pressure relief valve, and then back to the water tank, (iv) Coolant pump, wherein the coolant pump is capable of circulating water from holding tank to battery pack and then back to coolant pump, and then to battery pack again, (v) Manifold, (vi) Hose reel that comprises a hose, wherein the manifold is capable of directing water to the hose that is comprises by the hose reel, (viii) Jump Jet Valve and Relief Valve, wherein water tank is directly downstream of both Jump Jet Valve and Relief Valve, wherein the method for assembling a plurality of electrical components that comprises the steps of connecting:

(a) AC motor that is operably linked to water pump,

(b) DC/AC converter that is operably linked to AC motor, and that is capable of transmitting AC current to said AC motor,

(c) Battery pack that is operably linked to DC/AC converter, and also operably linked to coolant pump, wherein said coolant pump delivers cooling water to battery pack, and wherein said DC/AC converter is capable of recharging said battery pack,

(d) Programmable Logic Controller (PLC) that is operably linked to DC/AC converter and to pressure sensor,

(e) Pressure gauge and pressure sensor, wherein manifold is operably linked directly with pressure gauge, and wherein pressure sensor is operably linked to pressure gauge, and where said pressure sensor is capable of sensing water pressure in said manifold,

(f) Hose reel motor and DC/DC converter, wherein said hose reel motor is operably linked to hose reel, and wherein DC/DC converter is operably linked to hose reel motor, and

(g) Hose reel, hose, and hose reel motor, wherein hose reel motor is capable of rotating the hose reel, thereby rolling out the hose or rolling in the hose.

In methods for operating embodiments, what is provided is a method for operating the above system, wherein the system further comprises a pulsing device, a throttle, a mechanical potentiometer, the method comprising the steps of:

(A) Filling holding tank with water,

(B) Inserting jetter hose and nozzle into a line that needs cleaning, and wherein the line has a “clean-out port,” the jetter hose and nozzle are inserted into said “clean-out port,” where optionally the line can be a drain line, a main sewer line, a conduit, or a pipe, wherein the hose is optionally inserted by one person, and wherein the pressure from the jetter to the nozzle drives hose into mainline by pressure of water coming out of the nozzle assists in pulling the hose into the line, and wherein the nozzle has backwards facing jets that assist in pulling the hose into the line,

(C) Turning on power, wherein the power is turned on by a switch on the PLC controller,

(D) Adjusting the throttle via a mechanical potentiometer, or setting a pre-programmed RPM via human machine interface (HMI) to the desired RPMs and pressure, in order to pull the hose and nozzle into the line that needs cleaning, where the goal is to clear blockages or stoppage,

(E) Optionally turning on the pulse in order to help push the jetter hose through the line, wherein the pulse causes the hose to vibrate and wherein the vibration assists in pushing the hose through the line,

(F) Allowing the pressure relief valve to set itself automatically to 4,000 pounds per square inch (psi),

(G) Allowing the line to be cleaned by water originating from the holding tank, and then transported through the hose, and then driven out of the nozzle, and

(H) Turning off the water pump, turning on the power to the hose reel, winding the hose back on the hose reel, and then turning off the power to the hose reel.

### BRIEF DESCRIPTIONS OF THE FIGURES

FIG. 1. Schematic diagram, where some components are shaped, showing fluid flow devices, electrical devices, regulatory devices, and connections.

FIG. 2. Schematic drawing, where all components are rectangles, showing fluid flow devices, electrical devices, regulatory devices, and connections. FIG. 2 shows additional components that are not shown in FIG. 1, namely, hose reel motor (15), coolant pump (16), and DC/DC converter (17).

FIG. 3. Schematic drawing mainly showing electrical devices that are linked to motors and pumps.

### DETAILED DESCRIPTION OF THE INVENTIONS

The present inventors have discovered industrially and economically efficient ways to make and use improved pump-based systems which constitute progress in science and the useful arts, it is respectfully proposed. Likewise, Artisans understand that the interchangeability of aspects of the instant systems with extant schemas is both contemplated and encouraged as within the scope and meaning along with claimed terminology and equivalents of the present inventions, it is respectfully submitted.

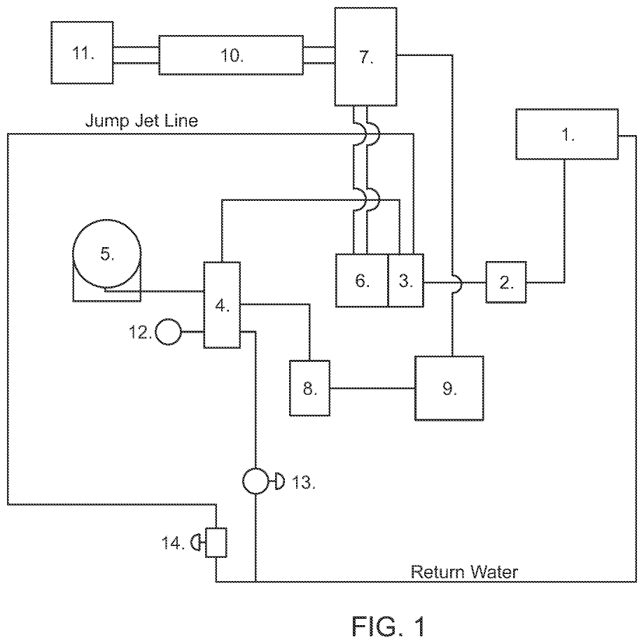

DETAILED DESCRIPTION OF FIG. 1. Structure numbers are as follows. (1) Water tank (also known as, holding tank). (2) Housing with filter inside. (3) Pump. (4) Manifold. (5) Hose reel. (6) AC motor for driving the pump. (7) DC/AC Converter and J Box. (8) Pressure sensor. (9) Programmable Logic Controller (PLC). (10) Battery pack (batteries). (11) AC/DC charger. (12) Pressure gauge. (13) Pressure relief valve. (14) Jump jet valve. The jump jet line runs between (3) PUMP and (14) JUMP JET VALVE. Return water moves from (13) Pressure relief valve to (1) Water tank, and also from (14) Jump jet valve to (1) Water tank. A smaller 12 Volt DC pump (16) is controlled via the PLC controller (9) to provide cooling for the battery pack (10), the cooling liquid is drawn from the water tank (1). The pressure gauge (12) can be an analog pressure gauge. Reel motor (15) can also be called, hose reel motor (15). Return water flows from jump jet valve (14) to holding tank (1).

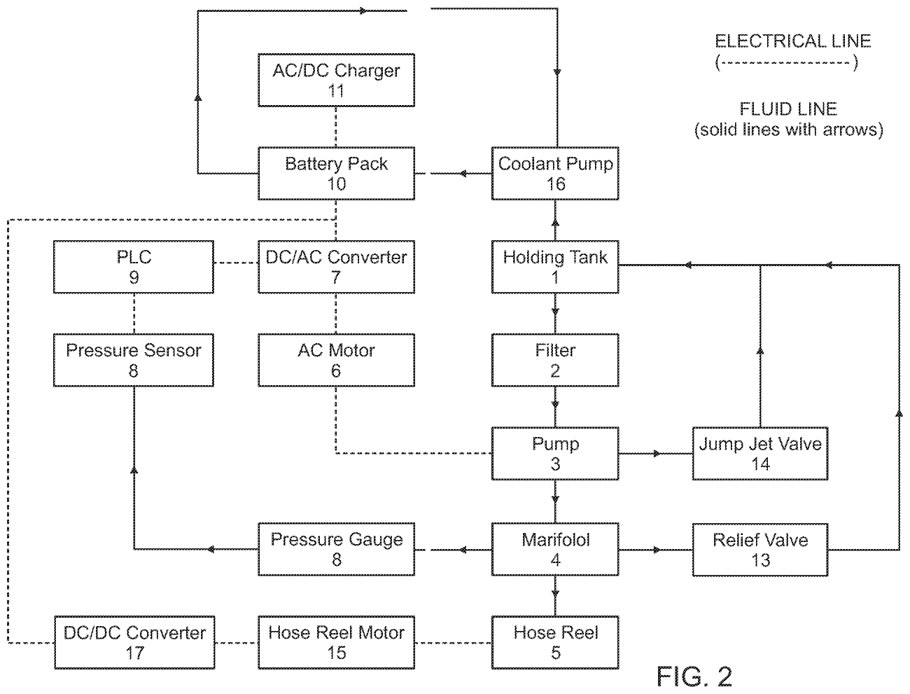

DETAILED DESCRIPTION OF FIG. 2. Electrical lines are shown with a dashed line. Fluid lines are shown with a solid line that has arrows indicating direction of fluid flow. (1) Holding tank. (2) Filter. (3) Pump. (4) Manifold. (5) Hose reel. (6) AC motor. (7) DC/AC converter. (8) Pressure sensor. (9) PCL (Programmable Logic Converter). (10) Battery pack. (11) AC/DC charger. (12) Pressure gauge. (13) Relief valve. (14) Jump jet valve. (15) Hose reel motor. (16) Coolant pump. (17) DC/DC converter.

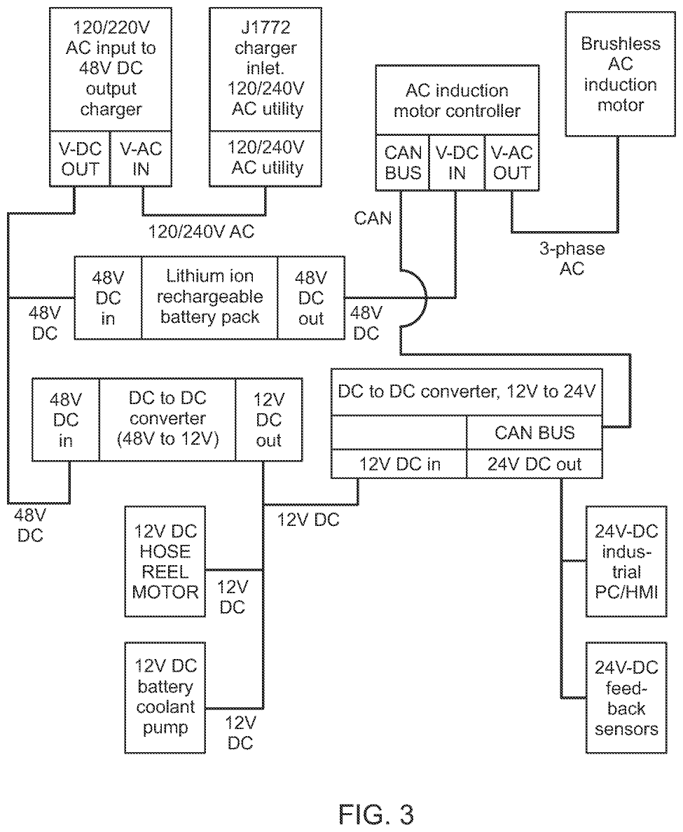

DETAILED DESCRIPTION OF FIG. 3. Devices that occur at the terminus of an electrical line are identified below. Also disclosed below are descriptions of the electrical lines that connect adjacent devices in system of the present disclosure:

(21) 120V/220V AC input to 48V DC output charger, with V-DC OUT terminal and V-AC IN terminal.

(22) J1772 charger inlet. 120V/240V AC utility, with 120V/240V AC utility. (21) and (22) are connected by 120/240V AC.

(23) AC induction motor controller, with V-DC IN terminal and VC-AC OUT terminal.

(24) Brushless AC induction motor. (23) and (24) are connected by 3-phase AC.

(25) Lithium ion rechargeable battery pack. In embodiments, battery pack includes only one battery, only two batteries, only three batteries, only four batteries, only five batteries, or at least one battery, or at least two batteries, or at least three batteries, or at least four batteries, or at least five batteries, or 1-2 batteries, or 1-3 batteries, or 1-4 batteries, or 1-5 batteries, or 2-3 batteries, or 2-4 batteries, or 2-5 batteries, and so on.

(26) DC to DC converter (48V to 12V). Termini to this DC to DC converter are 48V DC in terminus and 12V DC out terminus.

(27) DC to DC converter, 12V to 24V. Termini to this DC to DC converter are, 12V DC IN and 12V DC OUT. Converter (26) is linked to Converter (27) with a 12V DC electrical line.

(28) 12V DC hose reel motor. This motor receives direct current from the DC to DC converter (26).

(29) 12V DC battery coolant pump.

(30) 24V-DC industrial PC/HMI.

(31) 24V-DC feedback sensors.

In the figure, each device is represented by a rectangle. Each of the lines that reside in between two different devices can represent a pair of wires that run parallel to each other, where both wires transmit either direct current or alternating current. Devices that transmit alternating current (AC) include the charger inlet (22), and the brushless motor (24). Alternatively, a line that resides in between two different devices can represent one wire, where that one wire transmits either direct current or alternating current. In this context, “terminus of an electrical line” refers to one of these pairs of wires that is strung from a first device to a second device, but where there is not any pair of wires that is strung from this second device to a third device.

In this context, the term, “reside in-between” refers, for example, to the situation where a worker runs his finger along one of the wires that operably links one device to another device, and where the finger does not bump into any intervening device. The term “reside in-between” two devices does not include any “out terminus” that is part of one of the devices, and also does not include any “in terminus” that is part of one of the devices.

EXCLUSIONARY EMBODIMENTS. In embodiments, systems, devices, and related methods of the present disclosure can exclude any system, device, and related method, where one or more intermediary devices occurs between AC input to DC output charger and charger inlet AC utility. In embodiments, systems, devices, and related methods of the present disclosure can exclude any system, device, and related method, where one or more intermediary devices occurs between DC hose reel motor and battery coolant pump. In embodiments, systems, devices, and related methods of the present disclosure can exclude any system, device, and related method, where one or more intermediary devices occurs between industrial PC/HMI and feedback sensors. In embodiments, systems, devices, and related methods of the present disclosure can exclude any system, device, and related method, where one or more intermediary devices occurs between lithium ion rechargeable battery (or battery pack) and AC induction motor controller. In embodiments, systems, devices, and related methods of the present disclosure can exclude any system, device, and related method, where one or more intermediary devices occurs between lithium ion rechargeable battery (or battery pack) and AC input to DC output charger. In embodiments, systems, devices, and related methods of the present disclosure can exclude any system, device, and related method, where one or more intermediary devices occurs between lithium ion rechargeable battery (or battery pack) and DC to DC converter.

This concerns the question of whether the DC/AC converter a step down converter. The patent application states that structure number (7) is a step down converter and that structure number (7) is also a DC/AC converter. Shawn Bennett provides this guidance. The primary function is converting from DC to AC voltage, it is not necessarily a step-down converter as the output voltage may vary. Paragraph 00128 states that, “J/Box (7) is operably linked to DC/AC converter (7).

The following concerns how the parts of J/Box interact with the parts of the DC/AC converter. The following concerns the question whether these parts include electrical wires, or an electrical feedback circuit, or gears, or springs. Shawn Bennett provides this guidance. The “J/Box” is just a housing where the DC to AC Converter is placed for environmental protection purposes. FIG. 2 has a rectangular box with the number (7), and it shows that the DC/AC converter (7) is connected to PLC (9), connected to Battery Pack (10), and that it is connected to AC Motor (6). This concerns the question about whether the J Box is also connected to PLC (9), connected to Battery Pack (10), and that it is connected to AC Motor (6).

The question is about whether the DC/AC converter (7) connected to the PLC (9), connected to Battery Pack (10), and also connected to AC Motor (6) or is it connected to only one or two of these things? Shawn Bennett provides this advice. The connections are accurate as shown, if there are no lines between components, there is no connection.

The following concerns the question, is the J Box (7) connected to the PLC (9), connected to Battery Pack (10), and also connected to AC Motor (6) or is it connected to only one or two of these things? Shawn Bennett answers, The connections are accurate as shown, if there are no lines between components, there is no connection. The following is a question about FIG. 2. FIG. 2 shows rectangle (7) containing the term, “DC/AC converter” but rectangle (7) does not also include the term, “J/Box.” Regarding the other figure, FIG. 1, none of the rectangles in FIG. 1 include any writing. In this letter to you, what is mentioned above is that your patent application states that, “J/Box (7) is operably linked to DC/AC converter (7).” A question is whether the following description is needed. “Even though one of the rectangles in FIG. 2 only contains the writing, “DC/AC converter (7),” the components represented by this rectangle include a DC/AC converter and also a J/Box.”

Shawn Bennett answers, Referring back to the answer about “J/Box” this is just a physical housing with no relationship to the working parts of the system. The DC to AC converter is inside of this box, but it's just that, a box with no functional purpose other than to keep water out. The following concerns another question, and this is about the electrical lines and electrical components of the inventive system. The provisional does a good job at describing that the battery pack drives the coolant pump, that the AC motor drives the water pump, and that the DC/DC converter is used to drive the hose reel motor. The provisional patent application does not clearly describe what the DC/AC converter does. Shawn Bennett answers, the DC to AC converter provides advanced control of the AC induction motor which drives the main j etter pump.

WATER PUMP. In FIG. 1 and in FIG. 2, the MOTOR (6) contains a rod or cylinder that can rotate, or another rotating member, wherein the rod or cylinder, or other rotating member is operably linked with pump (3), and where rotation of the rod, cylinder, or other rotating member, can drive movement of one or more components in the pump, such as one or more pistons (driving by way of a cam shaft), or a propeller, or a turbine, or a peristaltic device that is capable of compressingly rotating on a compressible hose. The rotating member that is rotated by the MOTOR (6) can be a linear member, or alternatively, it can comprise a first linear portion that is operably linked with a first gear to a second gear of a second linear portion, and where the second linear portion is directly connected to the pump, and is capable of driving the pump. The above description does not imply any limitation on the present invention.

In exclusionary embodiments, system, devices, and related methods of the present disclosure can exclude any system, device, and related method, where one of the following devices does not occur at the terminus of an electric line: (A) J1772 Charger Inlet, (B) Brushless AC Induction Motor, (C) 12V Hose Reel Motor, (D) 12V DC Battery Coolant Pump, (E) 24V DC Industrial PC/HMI, and (F) 24V DC Feedback Sensors. In this context, “terminus of an electrical line” refers to one of these pairs of wires that is strung from a first device to a second device, but where there is not any pair of wires that is strung from this second device to a third device.

In exclusionary embodiments, system, devices, and related methods of the present disclosure can exclude any system, device, and related method, where two or more of the following devices does not occur at the terminus of an electric line: (A) J1772 Charger Inlet, (B) Brushless AC Induction Motor, (C) 12V Hose Reel Motor, (D) 12V DC Battery Coolant Pump, (E) 24V DC Industrial PC/HMI, and (F) 24V DC Feedback Sensors. In this context, “terminus of an electrical line” refers to one of these pairs of wires that is strung from a first device to a second device, but where there is not any pair of wires that is strung from this second device to a third device.

Communications Between Parts of Applicant's Jetter System.

The system consists of a water tank (1) that is connected by plumbing to the input of a high-pressure water pump (3). Inline between the tank and water pump sits a sediment filter (2) and filter housing to prevent sediment from the tank entering the water pump. The water output of the water pump is connected by plumbing to a manifold (4) which is connected by plumbing to the hose reel (5). The hose reel supplies output water to a high pressure hose that is connected to the reel (5). The reel (5) is equipped with an electric motor (15) for retraction of the hose.

The motor is a 12Volt DC motor, and is connected to the battery pack (11) via a step down converter which receives 50V from the batteries and outputs 12 v to the electric motor. The batteries (10) are charged by an AC/DC charger. The charger (11) can receive 120Volt AC or 240Volt AC power and convert it down to 50Volt DC in order to charge the batteries (10). The batteries (10) are connected to the motor (6) via Junction Box (7) and PLC controller (9). The PLC controller (9) receives battery power and acts as a variable speed controller to allow precision control of RPMs via PLC logic, or a manual frequency control. A digital pressure sensor (8) is connected to manifold (4). The digital pressure sensor (8) is connected to the PLC. A smaller 12Volt DC pump (16) is controlled via the PLC controller (9) to provide cooling for the battery pack (11), the cooling liquid is drawn from the water tank (1).

EXCLUSIONARY EMBODIMENTS. Exclusionary embodiments regarding devices that are adjacent to each other and without any intervening devices. For the purposes of construing a claim that has a negative claim limitation, hardware such as, insulated electrical wiring, coaxial cables, pipes, hoses, joints, branching points in a pipe or hose such as T-branching points, are not considered to be “devices.” FIG. 2 provides an examples of an intervening devices, for example, filter (2) that intervenes between holding tank (1) and pump (3). FIG. 2 also provides the example of Programmable Logic Controller (PLC) (9) that intervenes between Pressure Sensor (8) and DC/AC convertor (7).

In embodiments, system, devices, and related methods of the present disclosure can exclude any system, device, and related methods where there is an intervening device between PLC and DC/AC Convertor, or where there is an intervening device between pressure sensor and PLC, or where there is an intervening device between pressure gauge and pressure sensor, or where there is an intervening device between manifold and a pressure gauge, or where there is an intervening device between relief valve and a manifold, or where there is an intervening device between relief tank and a holding tank, or where there is an intervening device between a battery pack (or a battery) and a DC/AC convertor, or where there is an intervening device between battery pack and a DC/DC convertor, or where there is an intervening device between a coolant pump and a holding tank, or where there is an intervening device between a holding tank and a filter (or a housing that contains a filter), or where there is an intervening device between a filter (or a housing that contains a filter) and a pump, or where there is an intervening device between a pump and a manifold, or where there is an intervening device between a manifold and a hose reel, or where there is an intervening device between a DC/DC converter and a hose reel motor, or where there is an intervening device between a holding tank and a jump jet valve, or where there is an intervening device between a pump and a jump jet valve, or where there is an intervening device between a coolant pump and a battery pack, or where there is an intervening device between a DC/AC convertor and an AC motor, or where there is an intervening device between an AC/DC charger and a battery pack.

LINES AND DEVICES THAT CARRY FLUIDS. CONTINUED INFORMATION ON THE ALGORITHMS FOR EXCLUDING A PRIOR ART SYSTEM. Precision can be added to the exclusionary embodiment, where a negative claim limitation added by amendment identifies the location of the intervening device, relative to an upstream tank, upstream filter, upstream pump, or upstream valve. This identifying location can be added by amendment, where the amendment states, “wherein the intervening device is between a tank and a filter, and is immediately upstream of the filter and immediately downstream of the tank.” Put in generic terms, the phrase added by amendment can read, wherein the instant system excludes any system that has an intervening device, and wherein the intervening device is immediately upstream of the (add name of the device that is in your system) and immediately downstream of the (add name of the device that is in your system).

Consider the situation where you want to exclude a system where there are two intervening devices, and where both of these intervening devices occur right next to each other between (add name of one device that is in your system) and (add name of other device that is in your system). The preceding sentence can be used as a generic algorithm for drafting the negative claim limitation.

Consider the situation where you want to exclude a system where there are three intervening devices, and where all three of these intervening devices occur right next to each other between (add name of one device that is in your system) and (add name of the other device that is in your system). The preceding sentence can be used as a generic algorithm for drafting the negative claim limitation.

Consider the situation where you want to exclude a system where there are four intervening devices, and where all four of these intervening devices occur right next to each other between (add name of one device that is in your system) and (add name of the other device that is in your system). The preceding sentence can be used as a generic algorithm for drafting the negative claim limitation.

ELECTRICAL LINES. Identifying which “device” is an “intervening device” for fluid lines that form a closed loop. Identifying which “device” is an intervening device” for electrical lines that form a closed loop.

The above algorithm can also be used for identifying which “device” is an intervening device for electrical lines that form a closed loop. The pathway of current can be defined as the pathway that occurs before the “power drop” or before the “Wattage” drop.

Methods for Operating Applicant'a Jetter System.

The pulsing device gets turned on and control panel diverts water back into storage tank makes piston two misfire to create a pulse in the hose line to pull hose and nozzle into sewer line or drain line. Increasing pressure or RPMs will make pulse faster and help pull hose and nozzle into line when mainline has multiple turns or long-distance and drain system.

A: Fill tank with water

B: Insert Jetter hose and nozzle into main sewer line or drain line.

C: Turn power to ON position via switch on PLC controller

D: Adjust throttle via mechanical potentiometer or set pre-programed RPM via HMI (human machine interface) to desired RPMs and pressure to help pull the hose and nozzle into line to clear blockage or stoppage.

E: turn on pulse if needed to help push hose through line due to length or multiple turns in drain system.

F: Pressure relief valve is set automatically to 4000 psi.

Additional Methods for Operating Applicant's System.

The hose and nozzle gets inserted through a “clean out” port on main sewer line or drain line or through main access to drain system. The hose can be inserted by one person and the pressure from machine to nozzle drives hose into mainline by pressure of water coming out of nozzle helps pull the hose into mainline. Most nozzles are designed with backward facing jets, which push the nozzle along into a pipe. The hose and nozzle gets pushed in to main sewer or drain line by hand and pressure going to nozzle helps pull the hose into mainline. If needed pulse jet is activated to help vibrate the hose into line. The hose reel has a electric motor to help pull hose back into reel.

Detailed Description Of Preferred Embodiments.

Abbreviations and non-limiting glossary. GPH is gallons per minute (rate of fluid flow). PSI is pounds per square inch (water pressure). DC is direct current. AC is alternating current. RPM is revolutions per minute. PLC is Programmable Logic Converter. V is volts. HMI is Human Machine Interface. AODD pump is, air-operated double-diaphragm pump. A device that is comprises a PLC and that is dedicated to comprising this PLC can be called, PLC controller or PLC assembly.

J Box, is short for Junction Box. This is a NEMA (National Electrical Manufacturers Association) enclosure for electrical components which may house a variety of electronic components. The J Box may be operably linked with the DC/AC converter (7). In our application, the J Box holds the following four components:

1st component of J Box: one electrical relay to isolate battery pack from the system when the disconnect switch is turned OFF (PLC function).

2nd component of J Box: one electrical relay to isolate battery pack from the control system when the key switch is turned off (part of PLC function) .

3rd component of J Box: two fuses for circuit protection.

4th component of J Box: one shunt resistor for determining a battery's charge status.

The term “operably linked” encompasses, without implying any limitation, a first electronic device that is “operably linked” to a second electronic device, and where the operable linkage is via one or more electric wires that conduct a current from the first to the second electronic device. Also, “operably linked” encompasses, a first device, such as a valve, pump, tank, and a second device, such as a valve, pump, or tank, where the operable linkage is via a pipe that permits transit of water from the first device to the second device. The term “operably linked” can also encompass communications between two different devices by way of wireless transmission, e.g., by radio waves, light waves, or sonic signals.

The term “pulse” refers, without implying any limitation, to an event that occupies a duration of time where fluid pressure increases or where fluid pressure decreases. This change in fluid pressure can be represented, for example, by a sine wave or by a square wave. Sine waves and square waves usually refer to events that are repeated at regular intervals. Alternatively, this change in fluid pressure can take the form of a single event (a single wave). The pulse rate can be, for example, one pulse per minute, or two, four, six, eight, ten, 20, 30, 40, 50, 60, 70, 80, 90, 100, 200, 300, 400, 500, 600, 700, 800, 900, 1000, 1200, 1400, 1500, 1600, 1700, 1800, 1900, or 2000 pulses per minute. In “about” embodiments, the pulse rate can be about one pulse per minute, or about two, about four, about six, about eight, about ten, about 20, about 30, about 40, about 50, about 60, about 70, about 80, about 90, about 100, about 200, about 300, about 400, about 500, about 600, about 700, about 800, about 900, about 1000, about 1200, about 1400, about 1500, about 1600, about 1700, about 1800, about 1900, or about 2000 pulses per minute. The term “about” can mean, plus or minus five percent, plus or minus ten percent, or plus or minus 15 percent, or plus or minus 20 percent. “Range” embodiments include a range definable by any two of the above values.

In exclusionary embodiments, system, device, jetter, and related methods can exclude any system, device, jetter, that provides a water pulse or a fluid pulse definable by one of the above pulse rates.

The present disclosure relates to improvements upon existing mobile, commercial and residential pressure washing and sewer line jetting systems. The present disclosure discloses systems capable of achieving great water pressure by utilizing a high pressure water pump for the purpose of cleaning surfaces, or unblocking drains and sewers. The present disclosure discloses a system in which the power train is an electric AC motor which is connected to a high pressure water pump. The present disclosure discloses that the AC motor is powered by a series of rechargeable DC batteries. The present disclosure discloses a water storage vessel which holds input water for process. The present disclosure discloses a series of plumbing that supplies input water to the high pressure water pump. The present disclosure discloses a series of plumbing that supplies high pressure process water to a hose reel. AC is alternating current and DC is direct current.

The improved system is capable of achieving output process pressure between 500 psi and 6000 psi by utilizing high power AC motor as the power train and a high pressure piston pump to drive the process water. The AC motor is coupled to the high pressure water pump via jaw couplings, gear drive, or belt drive in a manner to directly or indirectly drive the water pump shaft. High pressure plumbing connects the output of the water pump, to a hose reel. The hose reel houses a high pressure hose which is the conduit for high pressure process water. The hose can vary in length, but is typically 100 feet to 500 feet long and can be sent into drains and sewer lines to deliver high pressure process water directly to a blockage within a drain or sewer system.

The improved system of the disclosure can include a DC battery pack capable of providing power to the AC motor by means of a DC to AC converter positioned in line. The DC input is converted to AC output to power the AC motor. The battery pack is recharged by AC battery charger which can accept either 120 volt or 240 volt AC power from any commercial or residential power grid. The battery charger converts incoming AC to the necessary DC output in order to recharge the battery pack. The improved systems of the invention disclose a DC to DC step down converter which converts 67V to 12V to drive the hose reel motor for retraction of the hose. The improved systems of the invention discloses a DC to DC converter which converts 12V to 24V to power the Programmable logic controller. The programmable logic converter (PLC) of the system allows for precise control of the motor speed (RPM). The PLC of the improved systems measures process water pressure and is capable of switching the system off if an over pressure situation arises in the process water output line, typically caused by debris or a blockage in the process output hose. The PLC of improved systems projects vital data and allows for digital controls of the system via a Human Machine Interface (HMI). The HMI screen is programmed with digital buttons and displays to perform functions such as ON/OFF of the powertrain, throttling of the motor to various RPMs, measuring pressure in process water output line, switching the system off in the event of an overpressure alarm, displaying a battery life indicator, tracking machine hours over lifetime, and can be expanded in function based on the needs of the operator.

Manufacturers, Suppliers, and Related Descriptions

Jump jet valves and pumps are available from Harben, Inc., Cumming, Ga. Available pumps include the radial piston diaphragm P-type pump, the Hi-Q pump, and the Century pump. Fittings and adaptors for tubes and pipes are available from Swagelok, Torrance, Calif. Hoses, flexible tubing, filters, and valves, are also available from Swagelok. Valves such as ball valves, check valves, block and bleed valves, needle valves, and needle valves are available from Swagelok. DC/DC converters are available from InvertersRUs, Reno, Nev., and from Arrow Electronics, Huntsville, Ala. Motors and other industrial equipment are available from Grainger, Los Angeles, Calif. Industrial batteries are available from Industrial Battery, Villa Park, Ill., and from Evergreen Industrial Batteries, Valley View, Ohio. Water pumps can be acquired from Northern Tool +Equipment, Burnsville, Minn., and from Blackhawk Technology, Glen Ellyn, Ill. DC/AC converters are available from PowerStream, Orem, Utah, from Power Bright, Fort Lauderdale, Fla., and from Digi-Key Electronics, Thief River Falls, Minn. Another type of converter, an AC/DC converter, is available from XP Power, Sunnyvale, Calif., and also from Digi-Key Electronics. Valves, pressure sensors, and pressure gauges, are available from SensorsONE, Rutland, United Kingdom, and from International Waterjet, Alhambra, Calif.

In exclusionary embodiments, the systems, devices, apparatus, and related methods of the present disclosure can exclude any system, device, apparatus, or method that comprises one of the above devices or machines.

Available pumps include, centrifugal pump of the impeller type (this pump uses centrifugal force to pump water). Impellers have vanes that flow from the center of a metal disc to the outside edge of the metal disc. Three types of impellers are: (1) Closed impeller where vanes are sandwiched between two solid metal discs; (2) Semi-open impeller where vanes are attached to only one of the metal discs, leaving the other side open to the pump housing; and (3) Open impeller design that does not have any metal discs, where the vanes are open on both sides (information from Pumpbiz, Northbrook, Ill.). An impeller is a rotor located in a conduit that imparts motion to a fluid that passes through the conduit. An impeller can also be a blade of a rotor.

Available water pumps include 8,120 GPH and 94 PSI NorthStar water pump with silicon carbide seals (instead of using the commonly used aluminum oxide seals). Available is IPT self-priming water pump (8.400 GPH, 139 PSI) with cast iron diffusers, with cast aluminum impellers. Available is NorthStar water pump (10,550 GPH, 116 PSI) with silicon carbide seals. Available is Gol water pump (4,752 GPH) with ceramic seals (Gol Pumps Technology, Inc., Miami Fla.). NorthStar pumps are available from, Northern Tool +Equipment, Burnsville, Minn.

Available pumps include, axial flow pump (also known as a propeller pump), booster pump, and a centrifugal pump. A centrifugal pump can have one impeller, two impellers, three impellers, four impellers, five impellers, and so on. Available pumps include a canned motor pump (this is a seal-less centrifugal pump. The impeller is directly attached to the motor rotor, with a can separating the wetted rotor from the motor stator. Also available is, magnetic drive pump (this is a seal-less centrifugal pump that transmits the torque from the motor to the impeller by way of a rotating outer magnet, where the outer magnet transmits magnetic flux through a can to an inner magnet that is attached to the impeller. The inside of the can is isolated, with no shaft penetration, and the seal is isolated. Also available, is regenerative turbine pump (this is not a true centrifugal pump, but it works on the same kinetic principal as a centrifugal pump. Instead of an impeller with vanes, the turbine impeller has blades similar to those of a turbine). The above information is from, Pump Types Guide Find the Right Pump For the Job (PumpScout, Bend, Oreg.). PumpScout is owned by LeadMethod, Inc.

In exclusionary embodiments, the systems, devices, apparatus, and related methods of the present disclosure can exclude any system, device, apparatus, or method that comprises one of the above devices or machines.

Systems, devices, apparatus, and related methods of the present disclosure can also include, self-priming pump (this is a type of centrifugal pump that can be located above suction reservoir without an external priming system). What is also encompassed is submersible pump (entire assembly of pump and motor is submersible). Also encompassed is positive displacement pump (does not have impellers, but instead relies on rotating or reciprocating parts to directly push the liquid in an enclosed volume until enough pressure is built up to move the liquid). Further encompassed is diaphragm pump (a type of reciprocating positive displacement pump, where liquid is pumped by reciprocating diaphragm, driven by a solenoid, mechanical device, or a fluid drive). In addition, what can be encompassed is an air-operated AODD pump (any type of reciprocating diaphragm pump containing two diaphragms and is driven by air, and not directly driven by an electric motor). Above information from PumpScout.

Encompassed is flexible impeller pump (a type of rotary positive displacement pump with a rotating rubber impeller with vanes that bend and then straighten as the impeller rotates, to conform to the internal cam in the pump casing). Encompassed is peristaltic pump (this type of pump does not require a seal). Encompassed is a pump (can include double-acting piston, two double acting reciprocating pistons, three double acting reciprocal piston, or four, five, six, or more double acting reciprocal pistons). Moreover, what is encompassed is vane pump (uses a rotor with vanes where the vanes are located in slots, and where the vanes rotate inside an eccentrically shaped casing. As the rotor turns, the vanes move in and out of slots). Above information from PumpScout.

In exclusionary embodiments, the systems, devices, apparatus, and related methods of the present disclosure can exclude any system, device, apparatus, or method that comprises one of the above devices or machines.

Reagents, chemicals, solvents, filters, and instrumentation such as spectrophotometers, mixers, and rotary evaporators, are available from, e.g., Sigma-Aldrich, St. Louis, Mo.; Life Technologies, Carlsbad, Calif.; BD Biosciences, San Jose, Calif.; HIVID Millipore, Billerica, Mass.; Thomas Scientific, Swedesboro, N.J. What is available are fluorescent dyes, radioactive isotopes, electron-dense reagents, fluorettes (see, e.g., Rozinov and Nolan (1998) Chem. Biol. 5:713-728). Pressure sensors, including digital pressure sensors, are available from SensorsONE Limited (Barleythorpe, Oakham, Rutland, United Kingdom), Keyence (Itasca, Ill.), and Futek Advanced Sensor Technology (Irvine, Calif.).

Characterizing the Jetter of the Present Disclosure.

Flow rate, flow pressures, weight of jetter system.

Jetter of the present disclosure is outfitted with a pump that would be on a regular diesel system. The flow and pressures will be the same when compared to existing diesel machines. The areas of improvement of efficiency of the present jetter have to do with the reduction of weight of the overall system. Now, this relates to fuel consumption of the vehicle that the jetter is either being towed by, or if the jetter is directly mounted in a box truck. Our current estimates is that our electric system is 30% lighter than a comparably powered diesel system. Cost of ownership, maintenance, fluid changes are also reduced with this type of electrical design. Diesel systems require hydraulics to operate components on the system, likewise the diesel engine requires oil, filter changes, and obviously the diesel. Our jetter eliminates all hydraulics as well as oil and diesel, reducing maintenance costs and lowering overall cost of ownership.

In exclusionary embodiments, systems, components, methods of using, and methods of manufacturing, of the jetter of the present disclosure can exclude system, components, and methods of a jetter that comprises any kind of hydraulics, that comprises diesel systems requiring hydraulics to operate components of the system.

Selecting the type of nozzle to be best adapted with the cleaning application.

Jetter of the present disclosure includes a nozzle, where this jetter can be used for cleaning sewers, for cleaning irrigation pipes on farms, for cleaning buildings, for cleaning bridges, and so on.

Jetter system of the present disclosure is essentially a pressure washer. The application is usually determined by the nozzle that is attached to the output hose. If the owner or operator needs to unclog a pipe, he would use a long high pressure hose with a spinning jetter nozzle. The nozzle spins and can deliver high pressure jets in a 360 degree rotation. If the operator needs to wash streets, then he would remove the warthog nozzle and replace it with a high pressure washer gun attachment. The hose attachment determines the function of the rig.

Components of Jetter.

FIG. 1. Applicant's jetter includes the following devices: Water tank (1), filter (2), pump (3), manifold (4), hose reel (5), AC motor (6), DC/AC converter (7), pressure sensor (8), Programmable Logic Controller (PLC) (9), battery pack (10), AC/DC charger (11), pressure gauge (12), pressure relief valve (13), and jump jet valve (14), and reel motor (15). Jump jet line begins at pump (3) and ends at jump jet valve (14). Pressure sensor (8) can be a digital pressure sensor. Water tank (1) is also known as holding tank. Filter (2) is comprised by a housing. Reel motor (15) can also be called, hose reel motor. Reel motor (15) receive power from DC/DC converter (17). Battery pack (10) is cooled by coolant coming from coolant pump (16). The pressure gauge (12) can be an analog pressure gauge.

WATER PUMP. The water pump is a 3 (three) piston pump. Our research has shown that even the highest pressure pumps (20,000 psi) are 3 piston pumps as well. The piston pump does take some sort of motor oil. the water pump does indeed take oil to keep the internals lubricated. The motor is an electric motor that does not require any lubricants. The batteries are water cooled, as is shown on the Process and Instrumentation Diagram.

FLUID FLOW LINES (line of fluid flow); ELECTRICAL LINES. FIG. 1 includes solid lines that represent fluid flow, and dashed lines that represent electrical lines or that represent operable linkages that are not lines of fluid flow. An operable linkage that is not a line of fluid flow occurs between Hose Reel Motor (15) and Hose Reel (5). Another operable linkage that is not a line of fluid flow occurs between AC Motor (6) and Water Pump (3).

DIRECTION OF FLUID FLOW. The direction of the flow is always single direction. Meaning that the flow of water out of the pump will be moving to either the hose reel which supplies the main hose, or back to the holding tank by means of the manifold and valves. The pump will not ever reverse flow. When the pressure reducer valve is opened, water is redirected from the main line, via the manifold, back into the tank.

System has two motors, AC motor (6) that drives the water pump (3), and reel motor (15) that winds and unwinds hose from the reel (5). System has two valves, pressure releif valve (13) and jump jet valve (14). System has two pumps, water pump (3) and battery coolant pump (16).

Return water line starts at the intersection just downstream from the analog needle valve (13) and the jump jet valve (14), and water line concludes at water tank (1). “Water tank” may also be referred to as “holding tank.” “Analog needle valve” (13) may also be referred to as “pressure relief valve” (13). “Quarter turn valve” (14) may also be called, “jump jet valve” (14).

SOLID LINES (see, FIG. 1) indicate fluid lines that transport water from one device to another device in Applicant's jetter are indicated by solid lines that begin at one device and end at another device, together with the part number for the one device and the part number for the another device. A fluid line can take the form of a metal pipe, plastic pipe, flexible tube, and so on.

FIG. 2 provides a more detailed account of the electrical lines in Applicant's jetter. Also, FIG. 2 discloses devices that are in addition to those disclosed by FIG. 1. The additional devices that are shown in FIG. 2 are “battery coolant pump,” a DC to DC converter (48 volts to 12 volts), another DC to DC converter (12 volts to 24 volts), feedback sensors, industrial PC/HMI, charger inlet, and AC induction motor controller.

Inventor's Characterization of Jetter and Electrical Components.

The system consists of a water tank (1) that is connected by plumbing to the input of a high-pressure water pump (3). Inline between the tank and water pump sits a sediment filter (2) and filter housing to prevent sediment from the tank entering the water pump. The water output of the water pump is connected by plumbing to a manifold (4) which is connected by plumbing to the hose reel (5). The hose reel supplies output water to a high pressure hose that is connected to the reel (5). The reel (5) is equipped with an electric motor (15) for retraction of the hose. The motor is a 12 VDC motor, and is connected to the battery pack (11) via a step down converter which receives 50V from the batteries and outputs 12 v to the electric motor. The batteries (10) are charged by an AC/DC charger. The charger (11) can receive 120 VAC or 240 VAC power and convert it down to 50 VDC in order to charge the batteries (10). The batteries (10) are connected to the motor (6) via Junction Box (7) and PLC controller (9). The PLC controller (9) receives battery power and acts as a variable speed controller to allow precision control of RPMs via PLC logic, or a manual frequency control. A digital pressure sensor (8) is connected to manifold (4). The digital pressure sensor (8) is connected to the PLC. A smaller 12 VDC pump (16) is controlled via the PLC controller (9) to provide cooling for the battery pack (11), the cooling liquid is drawn from the water tank (1).

Additional descriptions drafted by the inventors.

The system includes a water tank (1) that is connected by plumbing to the input of a high-pressure water pump (3). In-line between the tank and water pump is a sediment filter (2) and filter housing to prevent sediment from the tank entering the water pump. The water output of the water pump is connected by plumbing to a manifold (4) which is connected by plumbing to the hose reel (5). The hose reel supplies output water to a high pressure hose that is connected to the reel (the hose is not shown). The hose reel (5) is equipped with an electric motor, the reel motor (15), for retracting the hose. The motor is a 12 volt motor, and is connected to the batteries (10) via a step down converter (7) which receives 50V from the batteries and outputs 12V to the electric motor. The motor can be varied in line voltage, 12V, 24V, 120V. The batteries (10) are charged by an AC/DC charger (11). The charger (11) can receive 120 v or 240 v AC power and convert it down to 50v DC in order to charge the batteries (10). The batteries (10) are connected to the motor (6) via J/Box (7) and PLC controller (9). The PLC controller (9) receives battery power and acts as a variable speed controller to allow precision control of RPMs via PLC logic, or a manual frequency control. J/Box (7) is operably linked to DC/AC converter (7).

A pressure sensor (8) is connected to manifold (4). The pressure sensor (8) is connected to the PLC (9). The pressure sensor serves several functions, one function is measuring output water line pressure and displaying said pressure reading onto the HMI screen which is part of the PLC (9) assembly. The second function of the pressure sensor is to act as an over pressure safety switch which is triggered by the PLC logic when a pressure above the set safety limit is experienced in the water output line. The set safety limit pressure can be adjusted within the PLC logic to accommodate different water pumps as well as different hoses. The pressure safety limit can be adjusted from 1 psi to 10000 psi. Typically, the safety pressure limit will be determined by either the pressure rating of the hose being used for a particular job, or a maximum pressure rating of the water pump. Pressure sensor (8) can be a digital pressure sensor.

Further descriptions drafted by the inventors.

The manifold (4) is also connected to an analog, spring action pressure gauge (12) capable of reading up to the maximum output pressure of the water pump. The manifold is also connected to an analog needle valve (13) capable of lowering the pressure in the main water output line by redirecting water flow back to the water tank. This pressure reducing valve allows operators to meter the pressure in the output line when less pressure is needed. This typically is the case for smaller line jobs where a smaller internal diameter hose is required to fit small kitchen pipes. The return water line is also connected to the water pump via a quarter turn valve (14). This auxiliary water line is called a “jump jet” or “pulse jet” line. When the jump jet valve (14) is in the OPEN position, water from a single piston in the pump is diverted back to the holding tank. This creates a pulse in the main water output line. The pulse jet or jump jet function is crucial to jobs that require the hose to enter a heavily blocked pipe, or where the blockage is past 100 feet of pipe. Pulsation in the output jet hose allows the hose to move more freely through debris or bends in water pipes.

Nozzles suitable for the systems, devices, components, and methods of the present disclosure.

We use several different nozzles on the machine, depending on what line we clean. We want the nozzle hole to be smaller to create a greater pressure in order to clean debris, roots or grease out of lines more thoroughly. A preferred manufacturer is Warthog Nozzles® (Durango, Colo.), available from, for example, A&H Equipment, Harrisburg, Pa., and Amazing Machinery, Cleveland, Tenn.. Available Warthog nozzles include, Model WV-1/4-A (front jet 0.024 inches; back jets 2×0.052 inches; flow 7-8 gallons/min); Model WV-1/4-B (front jet 0.020 inches; back jets 2×0.039 inches; flow 5-6 gallons/min); Model WV-1/4-C (front jet 0.018 inches; back jets 2×0.032 inches; flow 4-4.5 gallons/min); and Model WV-1/4-D (front jet 0.018 inches; back jets 2×0.028 inches; flow 3 to 3.5 gallons/min).

Warthog nozzles also include, WT-3/8 jetter nozzle (maximum pressure 5k pounds per square inch (psi), operating pressure 1.5 to 5.0 psi, rotation speed 300 to 500 revolutions per minute (rpm), flow 5 to 12 gallons per minute, flow rating 0.75 Cv, pulling force 5 to 20 pounds.

Warthog nozzles include WT-1/2 jetter nozzle (range of operating pressures, 1.2 to 5.0 thousand psi (kpsi)). This jetter nozzle can negotiate elbows in pipes. Rotation speed 300-500 rpm. Flow 5-21 gallons per minute.

Another Warthog nozzle is WS-1/2 (up to 5 thousand psi), designed to handle 4 inch to 8 inch lines with elbows. Operating perssure 1.5-5.0 kpsi. Rotation speed 200-500 rpm. Glow 8-20 gallons per minute. Pulling force 9-27 pounds.

Warthog nozzles further include JOINTED INLET MODELS that allow inlet hose to bend to the side, thereby allowing access to areas of limited access.

Warthog WS-P8 is described as excellent for straight pipes. The whip hose can be removed, allowing the hose to connect directly to the tool (maximum pressure 5 5 kpsi, operating pressure 1.5-5.0 kpsi, rotation speed 200-500 rpm, flow 8-20 gallons per minute, pulling force 9-27 pounds. Warthog WH-1/2 operates at 1.2 kpsi to 5 kpsi; rotation speed 150-350 rpm, flow 10-20 gallons per minute, pulling force 18-50 pounds. WH models are best for lines that are 6 inch to 18 inch lines.

In rotating embodiments, system, device, jetter, nozzle, and related methods encompass a jetter nozzle with rotation speed of, 5-100 rpm, 50-150 rpm, 50-200 rpm, 100-200 rpm, 100-300 rpm 100-400 rpm, 200-300 rpm, 200-300 rpm, 200-400 rpm, 300-400 rpm, 300-500 rpm, 300-600 rpm, 400-500 rpm, 400-600 rpm, 400-700 rpm, and so on. In exclusionary embodiments, the system, device, component, jetter, and related methods of the present disclosure can exclude any system, device, jetter, nozzle, that is describable by one of the above rotation speeds.

In operating pressure embodiments, the system, device, jetter, nozzle, and related methods encompass a nozzle with an operating pressure of 1.0-2.0 thousand pounds per square inch (kpsi), 1.0-2.5 kpsi, 1.0-3.0 kpsi, 1.-3.5 kpsi, 2-3 thousand pounds per square inch (kpsi), 2-4 kpsi, 2-5 kpsi, 2-6 kpsi, 2-8 kpsi, 2-10 kpsi, up to 2 thousand pounds per square inch (kpsi), up to 3 kpsi, up to 4 kpsi, up to 5 kpsi, up to 6 kpsi, up to 8 kpsi, up to 10 kpsi, up to 12 kpsi, up to 15 kpsi, up to 20 kpsi, and so on. In exclusionary embodiments, system, device, jetter, nozzle, and related methods can exclud any system, device, jetter, nozzle, and related method that includes nozzle that operates at one of the above pressures.

System, components, devices, and methods of the present disclosure can encompass one or more of the above-disclosed Warthog nozzles (or one of the below-disclosed nozzles), and can also encompass a nozzle that has the same diameters and flow characteristics as one of the above Warthog nozzles, including those that are actually Warthog nozzles and as well as similar nozzles that are made by other manufacturers. What is also encompassed is a nozzle that a flow rate of 0.5-1.0 gal/min, 0.5-2.0 gal/min, 0.5-3.0 gal/min, 1.0-2.0 gal/min, 1.0-3.0 gal/min, 1.0-4.0 gal/min, 2.0-3.0 gal/min, 2.0-4.0 gal/min, 2.0-5.0 gal/min, 3.0-4.0 gal/min, 3.0-5.0 gal/min, 3.0-6.0 gal/min, 4.0-5.0 gal/min, 4.0-6.0 gal/min, 4.0-7.0 gal/min, 5.0-6.0 gal/min, 5.0-7.0 gal/min, 5.0-8.0 gal/min, and so on. In exclusionary embodiments, the system, device, component, jetter, and method of the present disclosure can exclude any system, device, component, jetter, and method that delivers one of the above flow rates.

In exclusionary embodiments, the present system, components, devices, and methods can exclude any system, component, device, and method that comprise one of the above-disclosed Warthog nozzles or that comprises a nozzle (not made by Warthog) that has the same diameters and flow characteristics of one of the above-disclosed nozzles.

Flow ratings. Flow rating is expressed in erms of the Capacity Coefficient (Cv). The formula for calculating flow rating is this: Cv equals (cyclinder area in square inches×cylinder stroke in inches×compression factor×“A”)) divided by (stroke time in seconds×28.8). This formula and the “A” constants are published on the world wide web at, parker dot com/parkerimages/schrader/cat/english/FRL4cvsg dot pdf. This publication was made available by Parker Hannifin Corp., Cleveland, Ohio. The flow capacity of valves, connectors and other components in pneumatic systems is often expressed in Cv (see, Pneumatic Tips (Feb. 6, 2019) by Ken Korane, WTWH Media).

Flow ratings of Warthog nozzles. WV-1/4 jetter nozzle has flow rating of 0.8 Cv. WT-3/8 jetter nozzle has flow rating of 0.75 Cv. WT-1/2 jetter nozzle has flow rating of 0.75 Cv. WS-1/2 jetter nozzle has flow rating of 1.3 Cv. WH-1/2 jetter nozzle has flow rating of 3.0 Cv.

Systems, devices, jetters, nozzles, and related methods can include nozzle with Capacity Coefficient (Cv) of 0.1-0.2 CV, 0.1-0.4 Cv, 0.1-0.6 Cv, 0.1-0.8 Cv, 0.1-1.0 Cv, 0.1-1.2 Cv, 0.1-1.4 Cv, 0.1-1.6 Cv, 0.1-1.8 Cv, 0.1-2.0 Cv, 0.1-2.5 Cv, 0.1-3.0 Cv, 0.1-3.5 Cv, 0.1-4.0 Cv, and so on, as well as 0.2-0.4 Cv, 0.2-0.6 Cv, 0.2-0.8 Cv, 0.2-1.0 Cv, 0.2-1.2 Cv, 0.2-1.4 Cv, 0.2-1.6 Cv, 0.2-1.8 Cv, 0.2-2.0 Cv, 0.2-2.5 Cv, 0.2-3.0 Cv, 0.2-3.5 Cv, 0.2-4.0 Cv, 0.2-4.5 cV, 0.2-5.0 Cv, and so on, as well as, 0.4-0.6 Cv, 0.4-0.8 Cv, 0.4-1.0 Cv, 0.4-1.2 Cv, 0.4-1.4 Cv, 0.4-1.6 Cv, 0.4-1.8 Cv, 0.4-2.0 Cv, 0.4-2.5 Cv, 0.4-3.0 Cv, 0.4-3.5 Cv, 0.4-4.0 Cv, and so on, as well as, 0.6-0.8 Cv, 0.6-1.0 Cv, 0.6-1.2 Cv, 0.6-1.4 Cv, 0.6-1.6 Cv, 0.6-1.8 Cv, 0.6-2.0 Cv, 0.6-2.5 Cv, 0.6-3.0 Cv, 0.6-3.5 Cv, 0.6-4.0 Cv, 0.6-8.0 Cv, 0.6-10 Cv, and so on, as well as greater than 0.1 Cv, greater than 0.2 Cv, greater than 0.4 Cv, greater than 0.6 Cv, greater than 0.8 Cv, greater than 1.0 Cv, greater than 1.5 Cv, greater than 2.0 Cv, greater than 2.5 Cv, greater than 3.0 Cv, and so on.

In exclusionary embodiments, systems, devices, nozzles, and related methods can exclude system, device, jetter, nozzle, and related methods, where a nozzle has a Cv value that fits into one of the above-disclosed ranges.

Regarding the systems, devices, jetters, and nozzles of the present disclosure, we consider two types of the nozzles: 1) the model number WS-1/2 J PKG (Jointed Inlet) will be used for cleaning roots and debris out of lines; 2) the model number WT-1/2 (Jetter Nozzle) will be used to clean roots, grease and debris. The usage of these nozzles will depend on a line size.

External priming system. In a preferred embodiment, pump will not have a priming system. Based on our design the pump will be primed with water. Our pump will be self-priming due to water always being primed in the system.

In exclusionary embodiments, system, device, jetter, and related methods of the present disclosure can exclude any system, device, jetter, related methods, and the like that comprises an external primiing system or that comprises a priming system.

Fate of debris and sewage that is driven out of a sewer. When system, device, jetter, and related methods of the present disclosure are used to clean a sewer line or drain a line, debris flows down into a city line or into a holding tank. When debris goes down a city line, it will flow to a sewer treatment plant, or if debris goes into a holding tank, we will pump it out with a vacuum truck, and dispose of debris at a waste treatment center.

Sources of water used by the system, the jetter, and related methods of the present disclosure. Systems, device, jetters, or methods of the present disclosure can acquire water from a fire hydrant, from its own reservoir tank that is filled with water, from a tank truck, from the municipal water supply as available from, e.g., a residence, a house, or a business.

In exclusionary embodiments, system, device, jetter, and related methods of the present disclosure can exclude any system, device, jetter, or method that pulls water out of a lake, or that acquires water from a tank truck, or that acquires water from a fire hydrant, or that carries its own reservoir tank that is filled with water, or that acquires water from the municipal water supply as available from, e.g., a residence, a house, or a business. System, device, jetter, and related methods of the present disclosure can exclude any system, device, jetter, and related methods where the jetter is mounted on a frame, and where the frame has wheels configured for supporting the frame while the frame and jetter are moved over a surface such as the ground or such as a road.

System, device, jetter, and related methods of the present disclosure can exclude any system, device, jetter, and related methods that have an injection port for introducing chemicals that enhance or facilitate cleaning (cleaning that is accomplished by the fluid exiting the jetter's hose).

Excluding screw conveyors, internal combusion engines, plurality of nozzles, etc. System, device, jetter, and related methods of the present disclosure can exclude any system, device, jetter, and related methods that use an internal combusion engine, or that has a muffler, or that has two or more spray nozzles, or that has two or more jetter nozzles, or that has any kind of vibrator for example a vibrator that assists in drying chemicals, or that has a knuckle joint, or that has a vacuum debris tank, or that has a vacuum debris container, or that has a telescoping boom, or that has a screw conveyor, or that has a vibrating screen for separating solids from liquids.

Excluding heaters. System, device, jetter, and related methods of the present disclosure can exclude any system, device, jetter, and related methods that has a heater, or that has a heat transfer coil, or that has a device that is dedicated to heating water that is destined to be directed through and out of a hose, or that has a device that is dedicated to heating water destined to be direted through and out of a hose and where the heated water is at or over 23 degrees C. (room temperature), at or over 28 degrees C., at or over 33 degrees C., at or over 37 degrees C. (human body temperature at resting), at or over 42 degrees C., at or over 47 degrees C., at or over 52 degrees C., at or over 57 degrees C., and so on.

Inclusionary and exclusionary embodiments relating to water pressure and pressure of pulses. System, device, jetter, and related methods of the present disclosure can provide water that is destined to travel through a hose and be propelled out of a hose nozzle, and where the pressure is measured at a point prior to entry in the hose, or where the pressure is measured at about a mid-point of the length of the hose, or where the pressure is measured immediately prior to exit from hose nozzle (at which point, pressure may be the greatest), and where water pressure is at least 5 pounds per square inch (psi), at least 10 psi, at least 20 psi, at least 30 psi, at least 40 psi, at least 50 psi, at least 60 psi, at least 80 psi, at least 100 psi, at least 120 psi, at least 140 psi, at least 160 psi, at least 180 psi, at least 200 psi at least 250 psi, at least 300 psi, at least 350 psi, at least 400 psi, at least 450 psi, at least 500 psi, at least 550 psi, at least 600 psi, at least 650 psi, at least 700 psi, at least 750 psi, at least 800 psi, at least 850 psi, at least 900 psi, at least 950 psi, at least 1000 psi, and so on.

In exclusionary embodiments, system, device, jetter, and related methods of the present disclosure can exclude any system, device, jetter, fluid, water, and related methods, where water pressure or fluid pressure is describable by one of the above “at least” values.

In “about” embodiments, system, device, jetter, and related methods of the present disclosure can provide water that is destined to travel through a hose and be propelled out of hose nozzle, and where the pressure is measured at a point prior to entry in the hose, or where the pressure is measured at about a mid-point of the length of the hose, or where the pressure is measured immediately prior to exit from hose nozzle (at which point, pressure may be the greatest), and where water pressure is about 5 pounds per square inch (psi), about 10 psi, about 20 psi, about 30 psi, about 40 psi, about 50 psi, about 60 psi, about 80 psi, about 100 psi, about 120 psi, about 140 psi, about 160 psi, about 180 psi, about 200 psi about 250 psi, about 300 psi, about 350 psi, about 400 psi, about 450 psi, about 500 psi, about 550 psi, about 600 psi, about 650 psi, about 700 psi, about 750 psi, about 800 psi, about 850 psi, about 900 psi, about 950 psi, about 1000 psi, and so on.

In exclusionary embodiments, system, device, jetter, and related methods of the present disclosure can exclude any system, device, jetter, fluid, water, and related methods, where water pressure or fluid pressure is describable by one of the above “about” values.

Fate of debris or sewages removed by system and methods of the present disclosure.

In a preferred methods embodiment, after a sewer or a drain line is cleaned, the water and debris are directed to flow down a city line to a waste treatment center. When a main line has a holding tank, a company collecting the water and debris from it is responsible for deposing and recycling it. In exclusionary embodiments, systems, devices, jetters, and related methods can exclude any system, jetter, device, or method where water containing debris is recycled.

Batteries and battery recharging units preferred for systems, jetters, and methods of the present disclosure.

A variety of rechargeable batteries are suitable for the systems, jetters, and methods of the present disclosure. A preferred rechargeable battery is, Tesla® 18650 Lithium Ion Battery Pack. In preferred embodiments only rechargeable batteries are used. What is preferred is Lithium Ion Batteries, or any future developed batteries of higher performance capabilities. The battery pack is recharged by AC battery charger which can accept either 120 volt or 240 volt AC power from any commercial or residential powergrid. A preferred recharging unit is, Thunderstruck® TSM2500 Charge Controller (Thunderstruck Motors, Santa Rosa, Calif.).

Alternating current motors. Please name the model and manufacturer of your preferred AC motor. This concerns motors powered by AC current. A preferred motor is, HPEVS AC34 Motor (Hi Performance Electric Vehicle Systems (HPEVS, Ontario, Calif.). Available electric motors include, AC-9/AC-15; AC-9; AC-12; AC-20/AC-23; AC-34/AC-35; AC-50/AC-51; and the AC-34x2/AC35x2 dual motor (HPEVS, Ontario, Calif.).

Electric motors. Preferred starting DC voltage is 48 VDC, and preferred converted DC voltages are 12 VDC and 24 VDC. A preferred motor is, Warp 9 DC Motor. Electric motors are available from Net Gain Motors, Inc. (Lockport, Ill.) (www dot go-ev dot com). These motors are manufactured by Warfield Electric Motor Co. (Frankford, Ill.). These motors include, HyPer®, WarP®, WarP7®, ImPulse9®, TransWarP7®, TransWarP9®, TransWarP11®. Models of the Warp 9 motor include the Warp 9 Impulse Double Shaft, the Impulse Single Shaft and the Dbl 1.125″ CE Shaft.

Programmable Logic Controller (PLC). The PLC (structure number (9)) of the system allows for precise control of the motor speed (RPM). The PLC of the improved systems measures water pressure and is capable of switching the system off if an over pressure situation arises in the process water output line, typically caused by debris or blockage. The PLC projects vital data and allows for digital controls of the system via a Human Machine Interface (HMI). This describes the PLC of the systems, devices, jetters, and related methods of the present disclosure. The industrial PLC includes points of interface to the field devices:

Inputs—Speed Potentiometer, Level Sensors, Pressure Sensors, Flow Sensors

Outputs—Status Lights, Battery Pump Operation, Hose Reel Operation

CAN Bus to Motor Control—Start/Stop Command, Parameter Changes

Safety Interlock—Emergency Stop, High/Low Level Sensors

The above narrative also constitutes a description of the Human Machine Interface (HMI) of the present disclosure.

Advantages of using a DC to AC converter with a AC motor, compared with using a DC to DC converter and with a DC motor. This concerns special conditions or circumstances when an AC motor is better, and special conditions when a DC motor is better. AC induction motors require less maintenance and overall are more efficient in using the supplied power, which for a battery-operated system is of paramount importance. The AC motor is also capable of regeneration which can use an external force to use the AC motor as a generator, returning charge to the battery pack. Circumstances where a DC motor are a better option are if simplicity and cost are the prohibitive factors.

Sources of 120 volt AC current and 240 volt AC current. Not every electrical wire (and outlet) can handle higher voltage, such as 240 volts. If this fact is ignored, conductors can overheat, leading to fire hazards. One can easily distinguish between a 120 volt outlet and a 240 volt outlet. The 120 volt is used to plug in anything from a vacuum cleaner to a phone charging cable. In contrast, a 240 volt outlet is larger, with room for three individual plugs or four plugs of varying size. The 120 volt outlet can supply enough electricity for a microwave oven, refrigerator, or dishwasher. For other applications, 240 volt wiring and outlets may be required. A number of your appliances require more than 120 volt to run adequately and reliably, where these appliances include a washing machine, dryer, and oven. These appliances can run, to a sub-optimal extent, on 120 volts. An oven that is connected to a 120V wire will only produce a quarter of the heat it would produce if connected to a 240 volt outlet (see, Fred's Appliance, Cleveland, Ohio; fredsappliance dot.com).

Exclusionary Embodiments

In exclusionary embodiments, the systems, devices, apparatus, and related methods of the present disclosure can exclude any system, device, apparatus, or method that comprises, for example, a slewing ring gear, a vacuum blower, a boom (e.g. a supporting arm or brace), a DC/DC converter, a DC/AC converter, a camera, a video camera, a brushless DC motor, a device with a ferrite core, a hose reel, a hydraulic pump, a device that uses a magnetic field for inspecting pipes, one or more light emitting diodes (LEDs), a sprinkler head, a Wayne Ball (spirally grooved, inflatable, semihard rubber ball), a telescoping section (section of a pipe, tube, or conduit), a flexible section (section of a pipe, tube, or conduit), an electric winch, and the like. In inclusionary embodiments, the systems, devices, apparatus, of the present disclosure can encompass one or more of the above things.

As used herein, including the appended claims, the singular forms of words such as “a,” “an,” and “the” include their corresponding plural references unless the context clearly dictates otherwise.

All patents and published patent applications disclosed herein are hereby incorporated by reference. The present invention is not to be limited by compositions, reagents, methods, laboratory data, and the like, of the present disclosure. Also, the present invention is not be limited by any preferred embodiments that are disclosed herein. The specific embodiments described herein are offered by way of example only, and the invention is to be limited by the terms of the appended claims, along with the full scope of the equivalents to which such claims are entitled; and the invention is not to be limited by the specific embodiments that have been presented herein by way of example.

What is claimed is:

1. A system for cleaning debris from pipes and sewers, wherein the system is capable of removing debris from one or more of indoor plumbing, underground plumbing, out-of-doors plumbing, irrigation conduits, sewage systems that carry industrial wastewater, sewage systems that carry sanitary waste, and sewage systems that carry rainwater, wherein the system comprises, in combination:
(A) A series of electrical devices that can be represented on a flow chart as being closely related, wherein these electrical devices comprise:
(a) An alternating current (AC) battery charger that can accept either 120 volt or 240 volt AC power from any commercial or residential powergrid, wherein the battery charger converts incoming AC to the necessary DC output in order to recharge a battery pack,
(b) A rechargeable battery pack that supplies direct current (DC),
(c) A DC to AC converter that converts direct current from said battery pack to alternating current, and wherein the alternating current is used to drive an electic motor,
(d) An electric motor that is driven by the alternating current (AC) produced by the DC to AC converter,
(e) A water pump for pumping water from a water tank to a manifold, wherein the electric motor is coupled to the high pressure water pump via jaw couplings, gear drive, or belt drive in a manner to directly or indirectly drive the water pump shaft,
(B) A series of fluid flow devices that can be represented on a flow chart as being operably linked, wherein these fluid flow devices comprise:
(a) A water tank for storing water, wherein the stored water is used for said cleaning debris;
(b) A manifold and a hose reel, wherein said water pump for pumps water from the water tank to a manifold and then to a hose reel;
(c) Said manifold that is capable of receiving water from said pump, wherein the manifold is also capable of directing water to said hose reel, and wherein the manifold is also capable of directing water back to said water tank, wherein the percentage of water directed to hose reel and percentage of water directed back to water tank is controllable by the combination of a pressure sensor and a Programmable Logic Controller (PLC) assembly that comprises a PLC logic,
(C) A plurality of regulatory devices that regulate water flow, the regulatory devices comprising:
(a) A pressure sensor operably linked to the manifold, wherein the digital pressure sensor is operably linked to a PLC assembly,
(b) Wherein the PLC assembly comprises an HMI screen, wherein the pressure sensor functions to measuring output water line pressure and displaying said pressure reading onto the HMI screen, and wherein the pressure sensor also functions to act as an over pressure safety switch which is triggered by the PLC logic when a pressure above the set safety limit is experienced in the water output line, and wherein the set safety limit pressure can be adjusted within the PLC logic to accommodate different water pumps as well as different hoses, and wherein the pressure safety limit can be adjusted from 1 pounds per square inch (psi) to 10000 psi,
(c) An auxiliary water line (“jump jet” line or “pulse jet” line) and a jump jet valve, wherein the flow of water from the water pump to the jump jet line is controllable by the jump jet valve, wherein when the jump jet valve is in the OPEN position, water from a single piston in the pump is diverted back to the water tank, and wherein water from the single piston in the pump is diverted back to the water tank what is created is a pulse in the main water (the output hose).

2. The system of claim 1, wherein the pulse in the jump jet line is capable of enhancing the ability of the hose to enter a heavily blocked pipe, and enhances the ability of the hose to clear blockage that is past about 100 feet of pipe, and wherein the pulsation in the hose to allow the hose to move more freely through debris in water pipes, and to more easily to navigate bends in water pipes.

3. The system of claim 1, wherein the hose reel supplies output water to a high pressure hose that is comprised by the hose reel, wherein the hose reel is equipped with a reel motor for retracting the hose, wherein the reel motor is a 12 volt motor that is powered by said battery pack via the step down converter that receives 50V from the batteries and outputs 12V to the electric motor, wherein the motor can be varied in line voltage, such as a line voltage that is 12V, 24V, or 120V.

4. The system of claim 1, further comprising regulatory devices that comprise an analog needle valve that resides in-line between the manifold and the water tank, and
wherein the analog needle valve is connected to the manifold, and wherein the analog needle valve is capable of lowering the pressure in the main water output line by redirecting water flow back to the water tank, and wherein this pressure reducing valve allows operators to meter the pressure in the output line when less pressure is needed, and wherein less pressure is typically needed for smaller line jobs where a smaller internal diameter hose is required to fit small kitchen pipes,
an analog spring action pressure gauge that is not in line with any device that is operably linked with the water pump and with the water tank, but instead is linked directly to only to the manifold, and wherein the spring action pressure gauge is capable of reading up to the maximum output pressure of the water pump.

5. The system of claim 1, further comprising a charger and a charger inlet, wherein the charger is operably linked to said one or more batteries and is capable of recharging said one or more batteries, and wherein the charger inlet can receive alternating current (AC) from a 120/240 volt AC utility line.

6. The system of claim 1, further comprising a filter and a filter housing that resides inside the fluid line between the water tank and the water pump, wherein the filter is capable of removing sediment, sand, and plant matter, that originated from the water tank.

7. The system of claim 1 that is portable and that is optionally mounted on a truck, mounted on a trailer, or mounted on a frame that includes wheels that support the frame on a road or on the ground.

8. The system of claim 1 that is not portable and that is optionally mounted on a ground-based platform.

9. The system of claim 1, that further includes a 12 Volt DC pump that is controlled via the PLC assembly, wherein the small 12 Volt DC pumps provides cooling for the battery pack, and wherein the cooling is provided by liquid is drawn from the water tank.

10. The system of claim 1 that further comprises a J Box, wherein the J Box comprises:
(i) One electrical relay to isolate battery pack from the system when the disconnect switch is turned OFF (PLC function),
(ii) One electrical relay to isolate battery pack from the control system when the key switch is turned off (part of PLC function),
(iii) Two fuses for circuit protection, and
(iv) One shunt resistor for determining a battery's charge status.

11. The system of claim 10, wherein said J Box is operably linked with said DC to AC converter.

12. A method for manufacturing the system of claim 1, the method comprising assembling a plurality of devices for transmitting fluids, and comprising assembling a plurality of electrical components, wherein the method for assembling devices for transmitting fluids comprises the steps of connecting:
(i) Water tank, wherein the water tank is immediately downstream of jump jet valve and pressure relief valve, and is immediately upstream of filter housing and coolant pump,
(ii) Filter housing that comprises a filter,
(iii) Water pump for driving the circulation of water from water tank through filter through jump jet line to jump jet valve, and then back to the water tank, wherein the pump is also used for driving water from water tank through filter to manifold through pressure relief valve, and then back to the water tank,
(iv) Coolant pump, wherein the coolant pump is capable of circulating water from holding tank to battery pack and then back to coolant pump, and then to battery pack again,
(v) Manifold,
(vi) Hose reel that comprises a hose, wherein the manifold is capable of directing water to the hose that is comprises by the hose reel,
(viii) Jump Jet Valve and Relief Valve, wherein water tank is directly downstream of both Jump Jet Valve and Relief Valve,
wherein the method for assembling a plurality of electrical components that comprises the steps of connecting:
(a) AC motor that is operably linked to water pump,
(b) DC/AC converter that is operably linked to AC motor, and that is capable of transmitting AC current to said AC motor,
(c) Battery pack that is operably linked to DC/AC converter, and also operably linked to coolant pump, wherein said coolant pump delivers cooling water to battery pack, and wherein said DC/AC converter is capable of recharging said battery pack,
(d) Programmable Logic Controller (PLC) that is operably linked to DC/AC converter and to pressure sensor,
(e) Pressure gauge and pressure sensor, wherein manifold is operably linked directly with pressure gauge, and wherein pressure sensor is operably linked to pressure gauge, and where said pressure sensor is capable of sensing water pressure in said manifold,
(f) Hose reel motor and DC/DC converter, wherein said hose reel motor is operably linked to hose reel, and wherein DC/DC converter is operably linked to hose reel motor, and
(g) Hose reel, hose, and hose reel motor, wherein hose reel motor is capable of rotating the hose reel, thereby rolling out the hose or rolling in the hose.

13. A method for operating the system of claim 1, wherein the system further comprises a pulsing device, a throttle, a mechanical potentiometer, the method comprising the steps of:
(A) Filling holding tank with water,
(B) Inserting jetter hose and nozzle into a line that needs cleaning, and wherein the line has a “clean-out port,” the jetter hose and nozzle are inserted into said “clean-out port,” where optionally the line can be a drain line, a main sewer line, a conduit, or a pipe,
wherein the hose is optionally inserted by one person, and wherein the pressure from the jetter to the nozzle drives hose into mainline by pressure of water coming out of the nozzle assists in pulling the hose into the line, and wherein the nozzle has backwards facing jets that assist in pulling the hose into the line,
(C) Turning on power, wherein the power is turned on by a switch on the PLC controller,
(D) Adjusting the throttle via a mechanical potentiometer, or setting a pre-programmed RPM via human machine interface (HMI) to the desired RPMs and pressure, in order to pull the hose and nozzle into the line that needs cleaning, where the goal is to clear blockages or stoppage,
(E) Optionally turning on the pulse in order to help push the jetter hose through the line, wherein the pulse causes the hose to vibrate and wherein the vibration assists in pushing the hose through the line,
(F) Allowing the pressure relief valve to set itself automatically to 4,000 pounds per square inch (psi),
(G) Allowing the line to be cleaned by water originating from the holding tank, and then transported through the hose, and then driven out of the nozzle, and
(H) Turning off the water pump, turning on the power to the hose reel, winding the hose back on the hose reel, and then turning off the power to the hose reel.
